(19) United States
(12) Patent Application Publication
(10) Pub. No.: US 2026/0318819 A1
(43) Pub. Date: Oct. 15, 2026

(54) A TRIBOMETER HAVING TWO COOPERATING DRIVING UNITS FOR DETERMINING TRIBOLOGICAL INFORMATION OF A TRIBO PAIR

(71) Applicant: Anton Paar GmbH, Graz (AT)

(72) Inventors: Jörg LÄUGER, Stuttgart (DE); Siegfried HUCK, Mannheim (DE)

(73) Assignee: Anton Paar GmbH, Graz (AT)

(21) Appl. No.: 19/106,553

(22) PCT Filed: Aug. 16, 2023
(86) PCT No.: PCT/EP2023/072563

§ 371 Date: Feb. 25, 2025

(30) Foreign Application Priority Data
Aug. 26, 2022 (DE) 10 2022 121 632.2

(51) Int. Cl. G01N 19/02

(52) U.S. Cl. CPC G01N 19/02

(57) ABSTRACT

A tribometer is disclosed. In on example, the tribometer is for determining tribological information between a tribo pair of a first body and a second body. The tribometer comprises a first driving unit for driving the first body and the second body coupled thereto to perform a deflection and a second driving unit for applying a force impact to the second body which force impact is acting in the opposite direction to the deflection. A control unit is configured to control the second driving unit such that the force impact on the second body generated by the second driving unit increased with increasing deflection of the first body and the second body generated by the first driving unit until the second body detaches from the first body. A determination unit determines the tribological information based on a behavior of the tribo pair during said control.

This application is a national US phase of PCT/EP2023/072563 which claims the benefit of the filing date of the German Patent Application No. 10 2022 121 632.2 filed 26 Aug. 2022, the disclosure of which is hereby incorporated herein by reference.

### TECHNICAL FIELD

The disclosure relates to a tribometer, an arrangement, a method for determining tribological information and a use.

### TECHNOLOGICAL BACKGROUND

Tribology is generally concerned with the relative movement of surfaces of test bodies under the impact of force on one another. Friction, wear and lubrication are examined with the aim of characterizing and, if appropriate, optimizing the movement systems. The friction coefficients are measured, in particular, over relatively long periods of time on sliding pairings composed of different materials with or without lubrication, wherein it is possible for the parameters of normal force or pressure, sliding speed, moisture and temperature to be varied during the measurement. Tribometers are devices for measuring tribological variables. For tribological measurements, the frictional contact between the surfaces to be examined is decisive. It is possible to measure the contact (lubricated or unlubricated, i.e. with or without an intermediate layer of a material) between two test bodies composed of the material to be measured or the different materials to be measured.

For a tribometric examination, a test body (for example a block) can be pressed onto a moving lower surface and fixed by a mechanical spring. Thereby, the test body can be pulled in length (German: in die Länge gezogen), wherein the spring retracts the test body in the direction of its starting position. The force exerted by the spring on the test body increases with increasing deflection, since the spring expands with an increase in its restoring force. If the restoring force is greater than static friction, the test body slides back. The movement of the mass of the test body, its movement and velocity or its acceleration can be measured as a measured variable.

For example, a tribometric examination can be carried out at connection points at which plastic, leather, rubber and glass parts come into contact with one another. The basic structure of a tribotechnic system can encompass the system elements base body, counterbody, an optional intermediate material (for example lubricant) and an ambient medium. The concept of a tribological stress can represent a stress on the surface of a body by a contact and relative movement of a solid, liquid or gaseous counterbody. This can take place with a mechanical restoring by a mechanical spring or a mechanical torsion wire. Tribological test stands can evaluate a linear movement using a mechanical spring and a displacement sensor or acceleration sensor. It is also possible to carry out a rotational movement with a mechanical torsion wire and an optical measurement of the twisting of the wire.

However, said mechanical spring or said torsion wire do not allow a possibility of adjusting the spring force. Mechanical springs or torsion wires can change their characteristics over the course of time and are sensitive to mechanical loads and to the installation situation especially in the case of small forces or torques.

The so-called stick-slip effect or static sliding effect (German: Haftgleiteffekt) leads to a behavior referred to as backlash (German: Ruckgleiten) and can occur if the static friction is significantly greater than the sliding friction. In technical applications, the effect is usually undesirable since it can lead to noise, vibrations and to increased wear and material fatigue. In addition to noise and vibration reduction, the energy consumption can also be reduced and the service life of components can be extended by minimizing stick-slip effects. Existing stick-slip test stands are relatively complicated, are often suitable only for this application and are relatively inflexible. Especially in the area of small components, there are no suitable measuring methods for the stick-slip effect.

Conventional attempts to analyze the stick-slip effect were not very successful since an undesired interaction often occurs between a motor controller and the stick-slip phenomenon and the two effects cannot be sufficiently separated from one another.

DE 10 2014 112 807 discloses a method and a device for determining tribological measured values of test bodies with a rheometer, wherein the measuring parts of the rheometer are replaced by test bodies and the surfaces of the test bodies are moved in frictional contact relative to one another. It is provided that all of the parts of the rheometer which hold the test bodies in frictional contact and non-positive connection or which form the rheometer force circuit, including the spring unit which presses the test bodies against one another, are considered to be an oscillating system (German: Schwingkreis), that the oscillation properties of the spring unit are considered to be relevant for the oscillation properties of this oscillating system, and that the oscillation properties of the spring unit are set taking into account the resonant oscillations or resonant effects which are expected during the respective measurement and are caused by changing, different measuring conditions.

### SUMMARY OF THE DISCLOSURE

There may be a need to determine tribological information of a tribo pair in a simple, flexible and precise manner.

This need is met by the subject matter having the features according to the independent patent claims. Further exemplary embodiments are shown in the dependent claims.

According to an exemplary embodiment of the present disclosure, a tribometer for determining tribological information between a tribo pair of a first body and a second body coupled to the first body (wherein optionally an intermediate medium can be provided between the first body and the second body) is provided, wherein the tribometer comprises a first driving unit for driving the first body and the second body coupled thereto to perform a deflection, a second driving unit for applying a force impact to the second body which force impact is acting in the opposite direction to the deflection, a control unit configured to control the second driving unit such that the force impact on the second body generated by means of the second driving unit is increased with increasing deflection of the first body and the second body generated by means of the first driving unit until the second body detaches from the first body, and a determination unit for determining the tribological information based on a behavior of the tribo pair during said control.

According to another exemplary embodiment of the disclosure, an arrangement is provided which comprises a tribometer having the features described above and the tribo pair of the first body coupled to the first driving unit and the second body coupled to the second driving unit.

According to a further exemplary embodiment of the present disclosure, a method for determining tribological information between a tribo pair of a first body and a second body coupled to the first body is provided, wherein the method comprises driving the first body and the second body coupled thereto to perform a deflection by means of a first driving unit, applying a force impact to the second body which force impact is acting in the opposite direction to the deflection by means of a second driving unit, controlling the second driving unit such that the force impact on the second body generated by means of the second driving unit is increased with increasing deflection of the first body and the second body generated by means of the first driving unit until the second body detaches from the first body, and determining the tribological information based on a behavior of the tribo pair during said control.

According to a further exemplary embodiment of the present disclosure, a dual-motor rheometer for determining tribological information between a tribo pair of a first body and a second body coupled to the first body by means of simulating a returning (linear or non-linear) spring behavior by a motor of the dual-motor rheometer is used.

In the context of the present application, a “tribometer” can be understood in particular as an apparatus which is configured to carry out tribological measurements for characterizing a frictional contact between directly or indirectly coupled surfaces of a first body and a second body. Optionally, at least one further body can be involved in the frictional contact.

In the context of the present application, a “tribo pair” can be understood in particular as an arrangement having a first body and a second body, between which a direct or indirect frictional connection to be tribologically examined is formed. Optionally, a mediation medium, for example a lubricant, can be arranged between the first body and the second body. At least one additional body can also be provided, which tribologically supplements the tribo pair.

In the context of the present application, a “driving device” can be understood in particular as a controllable or regulatable device for providing a driving energy (in particular a driving torque or a linear driving force) for driving the first or second body. Preferably, such a driving device can be an electric driving device (for example an electric motor). However, hydraulic driving devices, pneumatic driving devices and/or combustion engines are also possible. In contrast to a mechanical spring, a driving device has a controllable driving characteristic.

In the context of the present application, a “deflection of a body” can be understood in particular as a change of a position, an angular position and/or another orientation of the body as a result of the provision of driving energy to the body.

In the context of the present application, a “loading of the second body with a force impact directed opposite to a deflection of the first body” can be understood in particular as the oppositely directed force impact on the second body being such that it inhibits the continuation of the deflection of the first body together with the second body coupled thereto (in particular in a frictionally engaging manner). Thus, the driving of the first body (and of the second body following the first body) and the oppositely directed force impact on the second body can denote torques and/or linear forces which are inverse or antiparallel to one another. For example, the second body can be loaded with a driving energy which has the tendency to rotate the second body in the opposite direction to the first body loaded with another driving energy. It is also possible to load the second body with a driving energy which has the tendency to move the second body linearly in the opposite direction as the first body loaded with another driving energy.

In the context of the present application, a “control device” can be understood in particular as an entity for the fully or partially automated control of the second driving device and optionally also of the first driving device. For example, such a control device can be software-controlled. For example, such a control device can be configured as a processor, part of a processor or a plurality of processors.

In the context of the present application, a “controlling that the force impact on the second body generated by means of the second driving unit is increased with increasing deflection of the first body and the second body until the body detaches from the first body” can be understood in particular as the oppositely directed force impact on the second body successively increasing in magnitude with continued deflection of the first body. This increase can be in particular linear or non-linear (for example quadratic). The force impact can be caused in particular by means of providing a torque and/or a linear force. If the continued and oppositely directed force impact on the two bodies continues to increase, at some point the frictional connection between the two bodies is torn off or released, so that the two bodies detach from one another.

In the context of the present application, “determining the tribological information based on a behavior of the tribo pair during said control” can be understood in particular as said driving of the bodies and said detachment event being able to be detected and being able to be set up until detachment with respect to the force impacts on the first body and the second body. Information about the frictional force characteristic between the first body and the second body can thereby be obtained.

In the context of the present application, a “dual-motor rheometer” can be understood in particular as a rheometer with two motor driving devices. Such a rheometer is originally designed specifically for carrying out rheological measurements. A rheometer is understood as a measuring device which applies a shear deformation and thus serves to determine the deformation and flow behavior of matter. According to an exemplary embodiment, such a dual-motor rheometer is reconfigured in particular in terms of control technology (further in particular in terms of software technology) in order to be adapted specifically for carrying out tribological measurements between a first body and a second body.

According to an exemplary embodiment of the disclosure, a tribometer for determining tribological information between a first body subjected to force by means of a controllable first driving device and a second body subjected to inverse force by means of a controllable second driving device is provided. Here, the oppositely directed force impact of the second body is successively increased with continued deflection of the first body together with the second body following it as a result of said force impact. This can be controlled in such a way that the second body initially follows the deflection of the first body due to a frictionally engaging connection to the first body as long as the inverse force impact of the second body does not overcome the adhesive force between the first body and the second body. If the latter condition is no longer met, the frictionally engaging connection between the two bodies breaks off, so that the second body detaches from the first body. This event can be detected and correlated with the force impact characteristic of the two bodies at the time of detachment. In this way, tribological information can be determined with respect to the pairing of the first body and the second body. This makes it possible to determine tribological information of the tribo pair in a simple, flexible and precise manner.

In contrast to a conventional mechanical spring or a conventional mechanical torsion wire, the second driving device preferably allows a possibility of adjusting a returning force. A preferably electric driving device also has the advantage that, in contrast to mechanical springs or mechanical torsion wires, it does not change its characteristics over the course of time and can be implemented in a fault-resistant manner even in the case of small forces or torques.

According to an especially preferred aspect, a dual-motor rheometer, which can already have a first driving device and a second driving device, but is designed for rheological measurements, can be reconfigured in terms of control technology in order to be able to supply tribological information in the described manner. Descriptively, it may be sufficient to retrofit such a dual-motor rheometer with a specific control device in terms of hardware technology and/or software technology in order to be able to provide the described tribometer functionality. In particular, it may be sufficient to install on such a dual-motor rheometer only a control software which can provide the described tribometer operation.

Additional exemplary embodiments of the tribometer, the arrangement, the method and the use are described below.

According to an exemplary embodiment, the first driving unit can be configured to rotationally drive the first body and the second body to perform an angular deflection, wherein the second driving unit is configured to apply a torque to the second body which torque is acting in the opposite direction to the angular deflection. The direction of rotation of the first body and initially also of the second body generated by means of the first driving unit can be opposite to a direction of rotation of the second body favored by means of the second driving unit during detachment. Such an exemplary embodiment is shown in FIG. 1.

According to another exemplary embodiment, the first driving unit can be configured to linearly drive the first body and the second body to perform a longitudinal deflection, wherein the second driving unit is configured to apply a longitudinal force impact to the second body which longitudinal force impact is acting in the opposite direction to the longitudinal deflection. The longitudinal movement of the first body and initially also of the second body along a corresponding direction generated by means of the first driving unit can be opposite to a longitudinal movement direction of the second body favored by means of the second driving unit during detachment. Such an exemplary embodiment is shown in FIG. 2.

According to an exemplary embodiment, the control unit can be configured to control the first driving unit and the second driving unit in a coordinated manner. Thus, a common control unit can coordinate or synchronize both driving units, so that especially reliable and reproducible results can be obtained.

According to an exemplary embodiment, the determination unit can be configured to determine the tribological information based on a time profile of a deflection of the second body. In particular, the determination direction can correlate a time of the torn off of the frictional connection between the first body and the second body with the force impact of the bodies by means of the driving units. This allows a conclusion to be drawn on the magnitude of the adhesive force between the first body and the second body. In the context of the evaluation of the time profile of the deflection of the second body, speed information and/or acceleration information can also be determined.

According to an exemplary embodiment, the control unit can be configured to repeat said controlling of the first driving unit and the second driving unit at least once after the detachment, until the second body detaches from the first body again. More precisely, the described driving, the described applying and the described controlling can be repeated as often as desired. The sequence of the driving of the two bodies by means of the first driving unit, the successively increased counter-driving of the second body by means of the second driving unit and the triggering of the torn off can be carried out at least twice, in particular as often as desired. The repetition is not only about averaging. The behavior can also change over time (for example as a result of abrasion). An irregular behavior can also result, but this is only noticeable if measurements are carried out over many repetitions. The obtained tribological information (for example the magnitude of the adhesive force between the two bodies) can thereby be refined (for example by averaging and/or by varying the driving forces).

According to an exemplary embodiment, the control unit can be configured to control the second driving unit such that the force impact on the second body generated by means of the second driving unit is increased proportionally to the deflection of the first body and the second body generated by means of the first driving unit until the second body detaches from the first body. In other words, the returning force impact of the second driving unit can be adjusted linearly to the deflection of the first driving unit. In this way, the motor-driven second driving unit can advantageously simulate the characteristics of a linear mechanical spring. However, it is advantageously possible with a motor-driven second driving unit to adjust the spring constant to a desired value or to adjust it flexibly by correspondingly influencing the motor drive.

According to an exemplary embodiment, the control unit can be configured to control the second driving unit such that the force impact on the second body generated by means of the second driving unit is increased non-linearly to the deflection of the first body and the second body generated by means of the first driving unit until the second body detaches from the first body. It is also possible to adjust the restoring force of the motor-driven second driving unit according to a non-linear characteristic curve. This can take place for example according to a returning force of the second driving unit increasing quadratically with the deflection of the first body as a result of the driving by the first driving unit. The obtained tribological information can thus be further refined by correspondingly influencing the motor drive of the second driving unit. In addition, the flexibility for a user to precisely define a tribological examination can be increased by specifying any desired non-linear characteristic curve.

According to an exemplary embodiment, the second driving unit can be a measuring motor of a tribometer that can also be operated in a rheometer configuration. Thus, in particular an existing dual-motor rheometer can be retrofitted in order to obtain tribological information between a first body and a second body. It is also possible to design the tribometer as a measuring device which can be used depending on a control software for carrying out tribological measurements or for carrying out rheological measurements, i.e. with a dual functionality. In particular, an existing dual-motor rheometer can be retrofitted with a control unit, in particular a control software, in order to make it possible to control the dual-motor rheometer for determining tribological information.

According to an exemplary embodiment, the tribometer can comprise a sensor unit, in particular comprising at least one angle sensor, for detecting a time profile of a deflection, in particular an angular deflection, of the second body as a basis for determining the tribological information. In particular, the angular deflection of the second body over time can be detected by sensors. Here, as long as the second body follows the driving of the first body by means of the first driving unit due to the adhesive force between the first body and the second body, an increase in the angular deflection can be determined by sensors. If the connection between the first body and the second body breaks off due to the successively increasing returning driving force of the second driving unit, whereby the second body can move back in the direction of its initial position, this can be determined by sensors by an abruptly returning deflection of the second body.

According to an exemplary embodiment, the tribometer can comprise an acceleration sensor for detecting acceleration information regarding the deflection, in particular an angular deflection. Such acceleration sensors are easy to implement, reliable and accurate.

According to an exemplary embodiment, the first driving unit can be arranged below the tribo pair and the second driving unit can be arranged above the tribo pair. A user can then comfortably mount and dismount the tribo pair of first body and second body in a vertical gap between the first driving unit and the second driving unit.

According to an exemplary embodiment, a first driving axis of the first driving unit can be aligned along a second driving axis of the second driving unit. For example, the first driving unit can be a first electric motor and the second driving unit can be a second electric motor, wherein the motor shafts of the two driving units can be aligned to one another along a common vertical direction.

According to an exemplary embodiment, the tribometer can comprise a receiving device for replaceably receiving the tribo pair. A user can attach a first body and a second body of very different geometry to this receiving device. The flexibility of the examination of samples with the tribometer is thereby further increased.

According to an exemplary embodiment, the control unit can be configured to adjust the force impact generated by means of the second driving unit according to a user specification, in particular by adjusting a driving current for driving the second driving unit. Although the control unit can be responsible and/or configured for carrying out an algorithm for carrying out a tribological measurement, a user can define one or more control parameters (for example via a graphical user interface). For example, a user can in this way adjust a spring constant of the motor-driven second control unit or specify a non-linear force-time characteristic curve of the motor-driven second control unit. The determination of tribological information by means of the tribometer can thus be adjusted flexibly to the requirements of a specific application.

According to an exemplary embodiment, the control unit can be configured to control the first driving unit at a constant rotational speed. This allows a simple control of the first driving unit. A time-variable control is then only necessary for the second driving unit.

According to an exemplary embodiment, the tribometer can comprise a tempering unit for tempering the tribo pair during the determination of tribological information. In this way, a temperature-dependent determination of the tribological properties between the first body and the second body is also possible. For example, a tempering chamber can enable a measuring temperature in a range between −170 °C and +1000 °C. A tempering of the tribo pair during the measurement can be advantageous in particular for lubricant tests.

According to an exemplary embodiment, the tribometer can comprise a moisture generator for moistening the tribo pair during the determination of tribological information. A moisture generator can be realized, for example, using a convection oven. As a result, the frictional properties between the first body and the second body can also be characterized as a function of the ambient moisture.

According to an exemplary embodiment, the tribometer can comprise a gas environment adjusting unit for adjusting a gas environment in an ambience of the tribo pair during the determination of tribological information. The adjustment of a gas environment in the ambience of the first body and of the second body can comprise the specification of a specific gas type (for example air, nitrogen, oxygen or a noble gas). Alternatively or additionally, the adjustment of a gas environment in the ambience of the first body and in the ambience of the second body can, however, include the specification of a specific gas pressure, for example normal pressure, positive pressure or negative pressure. If, for example, measurements are carried out in an oxygen-free or low-oxygen atmosphere (for example in a nitrogen or argon atmosphere), an undesired oxidation can be avoided.

According to an exemplary embodiment, the tribometer can comprise a further determination unit which is configured to determine further information of the tribo pair during the determination of tribological information. Such a further determination unit can, for example, be configured to determine information relating to an acoustic emission, an electrical conductivity, a dielectric property, a spectroscopic property and/or an optical property of the tribo pair. In this way, tribological information can be correlated with one or more further parameters.

According to an exemplary embodiment, the first body and the second body can be directly adjacent to each other. In other words, there can be a direct physical contact between mutually adjacent contact surfaces of the first body and of the second body. Then, a direct tribological characterization of the system of the first body and of the second body can be carried out.

According to another exemplary embodiment, the arrangement can comprise an intermediate medium, in particular a lubricant, between the first body and the second body. Then, it is possible to examine how the presence of an intermediate medium influences the frictional properties between the first body and the second body.

According to an exemplary embodiment, the determination of the tribological information can comprise characterizing a backlash between the first body and the second body. It is thus possible to carry out stick-slip measurements with the tribometer.

### BRIEF DESCRIPTION OF THE DRAWINGS

Exemplary embodiments of the present disclosure are described in detail below with reference to the following figures.

FIG. 1 shows a cross-sectional view of a tribometer with rotary motors according to an exemplary embodiment of the disclosure.

FIG. 2 shows a cross-sectional view of a tribometer with translationally acting motors according to another exemplary embodiment of the disclosure.

FIG. 3 shows a receiving device for receiving bodies of a tribo pair for characterizing by means of a tribometer according to an exemplary embodiment of the disclosure.

FIG. 4 shows another receiving device for receiving bodies of a tribo pair for characterizing by means of a tribometer according to another exemplary embodiment of the disclosure.

FIG. 5 shows a part of a tribometer according to an exemplary embodiment of the disclosure.

FIG. 6 and FIG. 7 show diagrams with measurement data which were obtained during the operation of a tribometer according to an exemplary embodiment of the disclosure.

FIG. 8 shows a part of a tribometer for measuring thread-shaped bodies of a tribo pair according to an exemplary embodiment of the disclosure.

FIG. 9 shows a part of a tribometer according to an exemplary embodiment of the disclosure.

### DETAILED DESCRIPTION OF THE DRAWINGS

Identical or similar components in different figures are provided with identical reference numbers.

Before exemplary embodiments of the disclosure are explained in more detail with reference to the figures, some general considerations are described on the basis of which exemplary embodiments of the disclosure were found.

According to an exemplary embodiment of the present disclosure, a tribometer is provided which comprises a first driving device for driving and deflecting a first body and a second body of a tribo pair to be analyzed. Furthermore, a second driving device is provided for applying a force impact to the second body which force impact is acting in the opposite direction. The force impact on the second body generated by means of the second driving device is advantageously increased with increasing deflection of the first body and the second body initially following it until the second body detaches from the first body when a frictional force limit is exceeded. This detachment at specific force conditions of the driving devices advantageously allows a simple, precise and flexible determination of tribological information of the frictional pairing from the first body and the second body.

Such a construction of a tribometer according to an exemplary embodiment of the disclosure advantageously allows in particular an examination of stick-slip phenomena with the aid of two rotary motors. A tribometer according to an exemplary embodiment of the disclosure can thus be used in particular as a measuring device which can make it possible to avoid or reduce stick-slip effects which are technically undesirable in many cases. From a hardware point of view, such a tribometer can be realized in that an existing rheometer with two rotary motors is retrofitted in terms of control technology, in particular in terms of software technology, in order to support a tribological measurement. Exemplary embodiments of the disclosure advantageously allow in particular stick-slip phenomena to be examined on a wide variety of material combinations and for quite different applications. The effort for realization can substantially consist in the software control of a dual-motor rheometer. This has the advantage that existing components (rheometer, second rotary motor, etc.) do not have to be newly developed. It is of course also possible to configure a tribometer according to an exemplary embodiment in terms of hardware technology in another way. It is advantageously also possible to monitor ambient conditions (such as, for example, temperature and/or moisture). A tribometer according to an exemplary embodiment of the disclosure advantageously offers the possibility of arranging a frictional contact between the first body and the second body with two driving units preferably configured as motors.

Descriptively, one finding of exemplary embodiments of the disclosure consists in simulating a torsion spring with a first driving unit preferably configured as an electric motor, and in using the second driving unit preferably configured as a further electric motor to specify a spring force or spring hardness. Here, during operation, the two motors preferably rotate in opposite directions, wherein their rotation axes can preferably be aligned to one another along a line. The two parts (i.e. the first body and the second body) of a tribo contact can be attached to the rotation axes (for example by means of an arrangement composed of a ball and three plates). The bodies of the tribo contact can be pressed against one another with a defined force. The tribo contact can optionally be measured with or without additional lubricant in between.

During operation, a motor (i.e. the first driving unit) can be moved at a rotational speed which is adjustable, for example. An elastic component (descriptively an electrically simulated spring) can be applied by the opposite motor (i.e. the second driving unit). The conversion can take place for example by specifying the torque, which can be proportional to the deflection angle. Below the static friction (so-called stick), the motor opposite the driving motor is pulled along. This takes place up to a point from which the contact in the tribo pair is torn off (so-called slip), and the motor is pulled back from the applied torque into the starting position. The process can be repeated as often as desired. A time-resolved measurement of the deflection angle can then be used to analyze the stick-slip phenomenon. A time-resolved rotational speed can be determined from the time-resolved angle measurement. The torque of the driving motor can likewise be recorded in a time-resolved manner and can be used to determine the frictional force. The conversion into tribological variables can take place for example via a known geometry of the measuring parts.

The spring strength of the second driving unit can advantageously be varied over a large range via a torque factor for restoring. For example, the spring strength can be adjusted by the driving current of the second driving unit.

By applying a viscous component (in particular to the second driving unit), an additional damping can be installed, which can be varied over a large range. Thus, for example, a distinction can be made between viscous and elastic components in the system.

Both driving units (in particular configured as motors, further in particular electric motors) can be configured identically. A respective driving unit can be air-mounted and allow the specification and the measurement of very low rotational speeds, deflection angles and/or torques.

The driving motor or the rotating mass of the driving motor (i.e. the first driving unit) including an associated measuring axis can be equipped with an increased inertia in order to keep low or even minimize influences of a jerky (German: ruckartig) resetting of the other motor (i.e. the second driving unit) on the rotational speed regulation. If the second driving unit recoils (German: zurückschlägt) after detachment of the second body from the first body, this can act on the first driving unit. By providing the first driving unit with an additional mass, a recoil of the second driving unit acts less strongly on the first driving unit, which improves the regulation accuracy of the first driving unit.

In addition to the specification of any desired rotational speeds, other desired movement profiles (for example rotational speed ramps, oscillating, sine, triangle, etc.) can also be specified to the first driving unit and/or the second driving unit.

According to an exemplary embodiment, the driving motor of the first driving unit can specify any desired torques and torque profiles.

According to an exemplary embodiment, it is also possible to specify complex profiles from any desired combinations of rotational speed, angle of rotation and/or torque. In particular, run-in processes at high velocities can also be specified before the actual stick-slip measurement.

According to an exemplary embodiment, a linear motor (in particular a lifting motor) can apply a tribological normal force (also referred to as load) in conjunction with a force sensor (for example a normal force sensor). The load can preferably be set over a large range, further preferably also within an experimental definition.

At least one motor axis of the first driving unit and/or of the second driving unit can contain a mechanical spring element in the axial direction. As a result, for example, a mechanical bias of the first body and of the second body against one another can be implemented. A normal force can be applied by an axial movement of one of the driving units (in particular of the upper driving unit), for example with a lift motor. The normal force itself can be measured capacitively via the deflection in the air bearing.

The driving motor of the first driving unit can be used for the run-in phase of the tribometer at very high rotational speeds and for the actual measurement at lower rotational speeds.

The test bodies (i.e. the first body and the second body and the attachment thereof to the tribometer) can have different shapes on both sides. For example, a geometry of a ball on three plates (or on three spheres, on three pins, etc.) is possible. Three pins (or sphere, studs, rollers, films, etc.) on a plate are also possible. The geometry of a disk on disk or a disk on plate can likewise be used.

Furthermore, according to exemplary embodiments of the disclosure, any desired materials and surface coatings can be provided on the respective sides of the tribo contact.

The tribo contact can be dry (i.e. no lubricant between the first body and the second body) or contain a medium between the first body and the second body, which medium serves, for example, as a lubricant.

Furthermore, an exemplary embodiment allows the ambient conditions, in particular the temperature, the moisture and/or special gases, to be monitored.

According to one exemplary embodiment, a combination with other measured variables is also possible. Examples thereof are an acoustic emission, an electrical conductivity, a dielectric spectroscopy and/or an optical method (for example contact microscopy, interferometry for gap measurement or wear determination, near-infrared spectroscopy, infrared spectroscopy, Raman spectroscopy in contact), etc.

Furthermore, according to one exemplary embodiment, a combination with an acceleration sensor in the measuring system is possible, which acceleration sensor holds the test body and re-regulates it via the adjusted spring constant. The data of the acceleration sensor can be compared or supplemented with those of the deflection angle of the measuring motor.

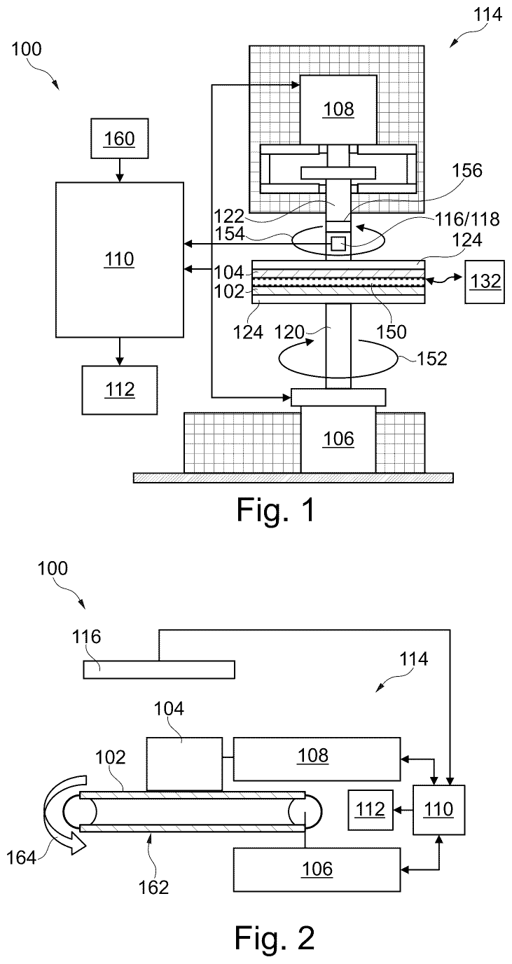

FIG. 1 shows a cross-sectional view of a tribometer 100 with two driving units 106, 108 configured as rotary motors according to an exemplary embodiment of the disclosure.

More precisely, FIG. 1 shows an arrangement 114 of the said tribometer 100 and a tribo pair, the frictional properties of which are to be determined. This tribo pair is formed from a first body 102 composed of a first material and a second body 104 composed of a second (preferably different) material, which bodies either have a direct physical contact with one another at mutually adjacent contact surfaces or—as illustrated in FIG. 1—are spaced apart from one another by an intermediate medium 150 configured here as a lubricant. The illustrated tribometer 100 serves to determine tribological information between the tribo pair of the first body 102 and the second body 104 coupled to the first body 102 by means of the intermediate medium 150.

The first body 102 and the second body 104 can be pressed against one another for a tribological examination. This can be achieved by means of a biasing element, for example by means of at least one mechanical biasing spring 156, which can generate an axial bias on the bodies 102, 104. For example, the mechanical biasing spring 156 can be attached to one or both of driving axes 120, 122, which are described in more detail below. It is also possible to apply a normal force by an axial movement of an upper driving unit 108 described in more detail below.

The tribometer 100 comprises a first driving unit 106 for driving the first body 102 to perform an angular deflection. More precisely, the first driving unit 106 according to FIG. 1 is configured as an electric rotary motor, which can cause a rotation about a first driving axis 120 represented by reference numeral 152. For example, the first driving unit 106 (also referred to as driving motor) can be controlled at a fixed rotational speed. According to FIG. 1, the first driving unit 106 is arranged below the tribo pair to be examined and can be controlled by means of a control unit 110 to carry out a rotation about its first driving axis 120, which can run clockwise according to reference numeral 152. The first driving unit 106 can thus be configured to rotationally drive the first body 102 to perform an angular deflection along a first direction of rotation. Since the first driving unit 106 is coupled to the first body 102 by means of its first driving axis 120 and a first part of a receiving unit 124, a rotation of the first driving unit 106 leads to a rotation of the first body 102. As already described, the first body 102 is frictionally connected to the second body 104 directly or by means of the intermediate medium 150. Therefore, in the absence of a sufficiently large force impact on the second body 104, the second body 104 can be rotationally entrained (German: mitgeführt) with the first body 102 when the first body 102 is rotationally driven by means of the first driving unit 106. This following of the second body 104 during rotational driving of the first body 102 is a consequence of the adhesive frictional force between the first body 102 and the second body 104, optionally mediated by the intermediate medium 150.

Again referring to FIG. 1, the tribometer 100 additionally comprises a second driving unit 108 for applying a force impact to the second body 104 which force impact is acting in the opposite direction to the angular deflection generated by means of the first driving unit 106. More precisely, the second driving unit 108 according to FIG. 1 is configured as a further electric rotary motor, which can cause a rotation about a second driving axis 122 represented by reference numeral 154, which is aligned in the vertical direction to the first driving axis 120. According to FIG. 1, the second driving unit 108 is arranged above the tribo pair to be examined and can be controlled by means of the control unit 110 to carry out a rotation about its second driving axis 122, which can run counterclockwise according to reference numeral 154. In other words, the first driving axis 120 and the second driving axis 122 rotate in opposite directions during operation. Therefore, the second driving unit 108 can be configured to apply a torque to the second body 104 which torque is acting in the opposite direction to the angular deflection caused by means of the first driving unit 106. Preferably, the second driving unit 108 (also referred to as counter motor) is configured as a regulated motor. Since the second driving unit 108 is coupled to the second body 104 by means of its second driving axis 122 and a second part of a receiving unit 124, a torque of the second driving unit 108 leads beyond a certain limit to a rotation of the second body 104 according to the driving direction of the second driving unit 108. Since the control unit 110 controls both driving units 106, 108, it is configured to control the first driving unit 106 and the second driving unit 108 in a coordinated manner. The control unit 110 controls the second driving unit 106 such that the force impact on the second body 104 generated by means of the second driving unit 108 is increased with increasing deflection of the first body 102 and the second body 104 generated by means of the first driving unit 106 until the second body 104 detaches from the first body 102. As a result, the second body 104 is quickly moved back in the direction of its original rest position by means of the second driving unit 108.

The movement characteristic of the first body 102 and the second body 104 forced by means of the control unit 110 is thus as follows: At the beginning, the first body 102 and the second body 104 frictionally connected thereto are rotated clockwise by means of the first driving unit 106. Descriptively, the adhesive frictional force between the first body 102 and the second body 104 causes the first body 102 set in rotation directly by means of the first driving unit 106 to entrain the second body 104 during its movement. However, the greater the angular deflection of the first body 102 and the second body 104 due to the rotational driving by means of the first driving unit 106, the greater the opposite driving force is adjusted by means of the control unit 110, with which the second driving unit 108 loads the second body 104 in the opposite direction to the deflection direction. For example, the second driving unit 108 can exert a counterforce on the second body 104, which is directly proportional (i.e. linear) to the driving force of the first driving unit 106, but is directed inversely to the latter. In this way, the second driving unit 108 simulates the behavior of an ideal mechanical return spring, which exerts a returning force on the second body 104. If the returning force of the second driving unit 108 on the second body 104 overcomes the adhesive force between the first body 102 and the second body 104, the frictional connection between the first body 102 and the second body 104 is released. Therefore, the second body 104 detaches from the first body 102. The second body 104 is now moved back in the direction of its rest position by means of the second driving unit 108, whereas the first body 102 can be moved further in the opposite direction by means of the first driving unit 106. The first body 102 can rotate further in the same direction. A return to its initial position is then not necessary. Alternatively, however, the first body 102 can now likewise be moved back again in the direction of its rest position by means of the first driving unit 106.

The force ratios at which a detachment of the second body 104 from the first body 102 takes place are indicative of the frictional force characteristic between the first body 102 and the second body 104.

A determination unit 112 can thus determine tribological information about the tribo pair of the first body 102 and the second body 104 frictionally coupled thereto by means of the intermediate medium 150 based on the described behavior of the tribo pair during said control. More precisely, the determination unit 112 determines the tribological information based on a time profile of the angular deflection of at least one of the bodies 102, 104, in particular of the second body 104. The time profile of the angular deflection can be supplied for example by means of at least one angle sensor of a sensor unit 116. Deviating from FIG. 1, the angle sensor (for example configured as an optical encoder) can be attached at the top above the bearing and not in the axis. Thus, information about the time dependence of the angular deflection of the second body 104 (and optionally also of the first body 102) can be transmitted to the determination unit 112. This can comprise the time period of the second body 104 moving along with the first body 102 and the time period of the second body 104 moving back after the detachment from the first body 102. It is also possible for the time dependence of the force impact of the first driving unit 106 and of the second driving unit 108 on the first body 102 or the second body 104 to be transmitted to the determination unit 112. In particular, the determination of the tribological information can comprise characterizing a backlash, i.e. a stick-slip, between the first body 102 and the second body 104.

The tribometer 100 can be configured to repeat the driving by means of the first driving unit 106, the applying by means of the second driving unit 108 and the controlling by means of the control unit 110 a further time or a plurality of times until the second body 104 detaches from the first body 102 again after the detachment. By recording the corresponding time dependence of the angular deflection during a plurality of sequences, the accuracy of the obtained tribological information can be further refined. Furthermore, it is thereby possible to record changes over time (for example as a result of abrasion or non-periodic behavior).

As already stated, the control unit 110 can be configured to control the second driving unit 108 such that the force impact on the second body 104 generated by means of the second driving unit 108 is increased directly proportionally (i.e. linearly) to the deflection of the first body 102 and the second body 104 generated by means of the first driving unit 106 until the second body 104 detaches from the first body 102. Alternatively to such a simulation of an ideal mechanical spring, the control unit 110 can be configured to control the second driving unit 108 such that the force impact on the second body 104 generated by means of the second driving unit 108 is increased non-linearly to the deflection of the first body 102 and the second body 104 generated by means of the first driving unit 106 until the second body 104 detaches from the first body 102. Such a non-linearity can be adjusted for example by non-linearly controlling the electric driving current of the second driving unit 108. For example, a quadratic dependence of the restoring force on the angular deflection generated by means of the first driving unit 106 can be adjusted.

It is especially preferred if the second driving unit 108 is a measuring motor of a tribometer 100 that can also be operated in a rheometer configuration. For this purpose, it is possible to use as a basis for the tribometer 100 an already existing dual-motor rheometer (configured to carry out a rheological analysis) for determining tribological information between the tribo pair of the first body 102 and the second body 104 coupled to the first body 102 by means of simulating a returning spring behavior by a motor of the dual-motor rheometer. For this purpose, it may be sufficient to retrofit said dual-motor rheometer with the control unit 110. It is even possible to use an already existing control unit of the dual-motor rheometer if a control software for controlling the dual-motor rheometer for determining the tribological information is installed on said control unit in the manner described above. The control software is then configured in particular such that the coordinated control of the first driving unit 106 and the second driving unit 108 for performing the common angular deflection of the bodies 102, 104 can be achieved until, triggered by a successively increasing returning force of the second driving unit 108, the second body 104 suddenly detaches from the first body 102.

FIG. 1 shows the already mentioned sensor unit 116 for detecting a time profile of the angular deflection as a basis for determining the tribological information. According to FIG. 1, the sensor unit 116 configured here as an angle sensor is located on the second rotational axis 122 of the second driving unit 108. Other sensors and/or sensor positions are of course possible. It is also possible to provide an acceleration sensor 118 for detecting acceleration information.

FIG. 1 moreover shows a user interface 160 via which a user can input control commands and/or control parameters for operating the tribometer 100. The control unit 110 can advantageously be configured to adjust in particular the force impact generated by means of the second driving unit 108 according to a user specification that can be input via the user interface 160. For example, the control unit 110 can adjust an electric driving current for driving the second driving unit 108 in order to map a user-defined spring constant in the case of a linear mechanical spring characteristic simulated by means of the second driving unit 108. Alternatively, the control unit 110 can adjust an electric driving current for driving the second driving unit 108 in order to simulate a user-defined non-linear characteristic curve in the case of a non-linear mechanical spring characteristic simulated by means of the second driving unit 108.

Optionally, the tribometer 100 can comprise at least one further determination unit 132 which is configured to determine further information of the tribo pair during the determination of tribological information. The at least one further determination unit 132 can, for example, be configured to determine information relating to an acoustic emission, an electrical conductivity, a dielectric property, a spectroscopic property and/or an optical property of the tribo pair. In this way, information about the tribological conditions of the tribo pair can be complementarily combined with further information obtained by measurement.

The tribometer 100 according to FIG. 1 thus shows, above and below the bodies 102, 104 configured as tribo contacts, a respective measuring motor of the driving unit 106, 108 with concentric position of the rotation axes. Two plates of the receiving unit 124 serve for the shearing of the bodies 102, 104 functioning as a sample between the plates. Measuring parts of the receiving unit 124 can be configured to be exchangeable and can comprise a measuring body recognition. The tribometer 100 can therefore recognize which measuring bodies are used, which tribological measuring modes shall be or can be implemented and/or which variables are to be set or specified. Furthermore, air bearings, components of a torque measurement via a current consumption of the respective motor, components for an angle measurement and/or components for a normal force measurement can be provided in the air bearing.

FIG. 2 shows a cross-sectional view of a tribometer 100 with driving units 106, 108 configured as translationally acting motors according to another exemplary embodiment of the disclosure.

In contrast to FIG. 1, FIG. 2 shows a tribo pair in which the first body 102 and the second body 104 are directly adjacent to each other. Alternatively, according to FIG. 2, a lubricant or another intermediate medium 150 can also be provided between the first body 102 and the second body 104.

According to FIG. 2, the first body 102 is attached to a conveyor belt unit 162 and is driven linearly by means of a first driving unit 106. More precisely, the first driving unit 106 causes a rotational drive of the conveyor belt unit 162 (see reference sign 164), which leads to a linear movement of the first body 102 due to the attachment of the first body 102 to the conveyor belt unit 162. A person skilled in the art will understand that the conveyor belt unit 162 shown in FIG. 2 is only an example of a drive for forming a linear movement. In other exemplary embodiments of the disclosure, other drives can be used for forming a linear movement, in particular any desired linear drives. In the illustrated operating state of FIG. 2, the first body 102 is moved horizontally to the left by means of the first driving unit 106. The first driving unit 106 is thus configured to linearly drive the first body 102 to perform a longitudinal deflection.

The second body 104 is placed directly onto the first body 102 and therefore initially follows the movement of the first body 102 in the horizontal direction to the left according to FIG. 2. However, the second body 104 is moreover coupled to a second driving unit 108 configured as a linear motor. The second driving unit 108 is configured to apply a longitudinal force impact to the second body 104 which longitudinal force impact is acting in the opposite direction to the longitudinal deflection due to the first driving unit 106. More precisely, the second driving unit 108 exerts on the second body 104 during a tribological measurement a force acting to the right in the horizontal direction according to FIG. 2, which force is inverse or antiparallel to the force exerted by means of the first driving unit 106 on the first body 102 and the second body 104. As long as the counterforce of the second driving unit 108 cannot overcome the adhesive force between the first body 102 and the second body 104, the second body 104 follows the movement of the first body 102. If the counterforce of the second driving unit 108 overcomes the adhesive force, the second body 104 is detached from the first body 102 and pulled away to the right in the horizontal direction according to FIG. 2. The counterforce provided by the second driving unit 108 is changed in time to trigger the detachment such that it increases proportionally to the longitudinal displacement of the second body 104 due to the force exerted by means of the first driving unit 106. Descriptively, the second driving unit 108 therefore simulates the behavior of an ideal mechanical spring and its restoring force proportional to the deflection. The spring constant of this mechanical spring can be adjusted to a predefinable value in a user-defined or software-controlled manner.

A sensor unit 116 configured for example as an optical position sensor can detect the time-dependent position information of the second body 104 and transmit it to the control unit 110. The control unit 110 can forward said sensor information to the determination unit 112 as well as the time-dependent force impact by the driving units 106, 108. From this information, the determination unit 112 can derive tribological information about the tribo pair of first body 102 and second body 104.

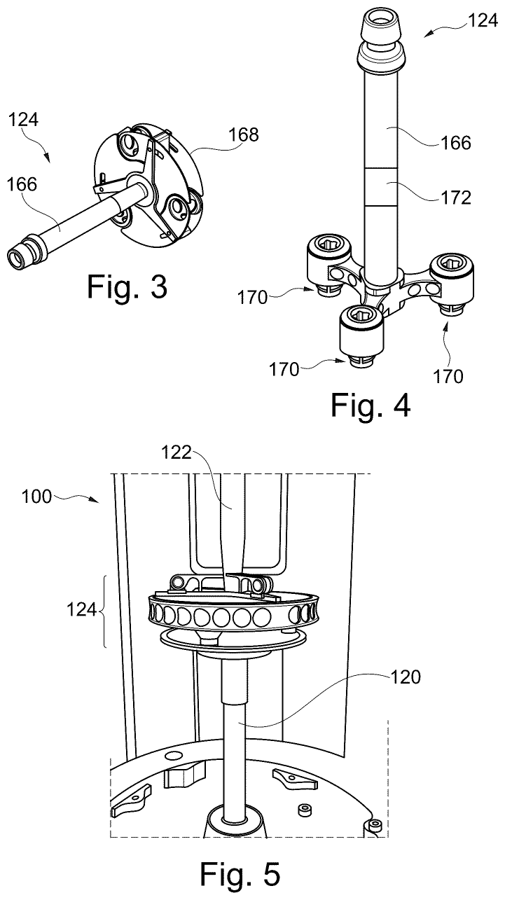

FIG. 3 shows a receiving device 124 for receiving bodies 102, 104 of a tribo pair for characterizing by means of a tribometer 100 according to an exemplary embodiment of the disclosure. FIG. 4 shows another receiving device 124 for receiving bodies 102, 104 of a tribo pair for characterizing by means of a tribometer 100 according to another exemplary embodiment of the disclosure.

The receiving devices 124 shown in FIG. 3 and FIG. 4 are especially well suited for a stick-slip measurement of the bodies 102, 104. These each include a measuring body axis 166. In the receiving device 124 according to FIG. 3, a disk holder 168 is provided. In particular, this receiving device 124 can comprise a screw-on pot (German: aufschraubbarer Topf) with fixing possibilities for a disk. According to FIG. 4, threaded tensioners 170 are provided. Furthermore, a spring element 172 can be attached to the measuring body axis 166, as shown by way of example in FIG. 4.

FIG. 5 shows a part of a tribometer 100 according to an exemplary embodiment of the disclosure. More precisely, a part of a corresponding experimental measuring apparatus is shown in FIG. 5. Below the illustrated receiving unit 124, the first driving unit 106 can be attached, which can comprise a motor running at a constant velocity during operation. Above the illustrated receiving unit 124, the second driving unit 108 can be implemented, which can simulate or emulate a spring behavior.

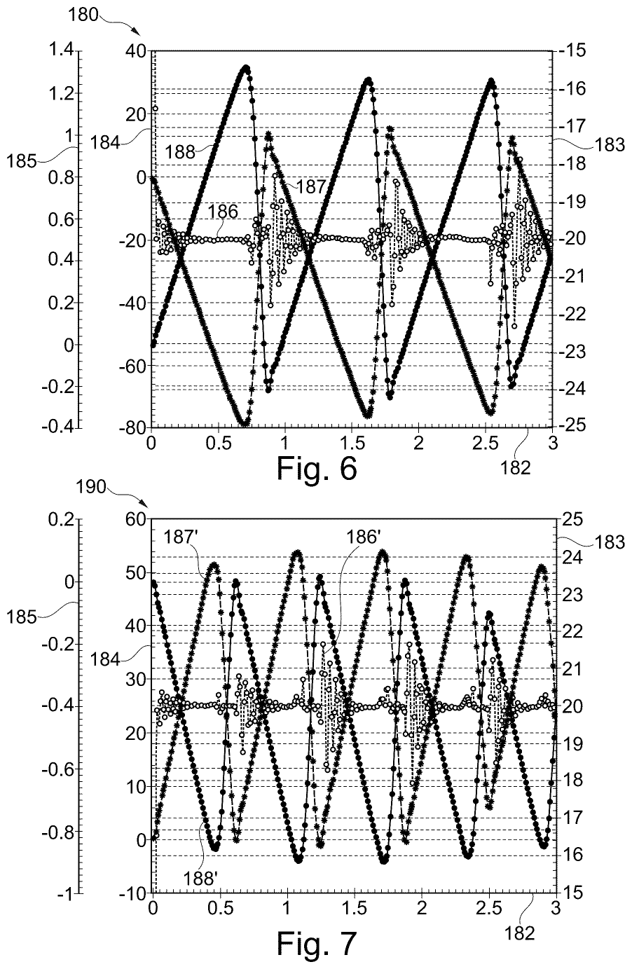

FIG. 6 and FIG. 7 show diagrams 180, 190 with measurement data which were obtained during the operation of a tribometer 100 according to an exemplary embodiment of the disclosure. Corresponding diagrams 180, 190 can be obtained, for example, with a tribometer 100 with a configuration according to FIG. 1. Diagrams 180, 190 show the results of stick-slip measurements.

The diagram 180 according to FIG. 6 has an abscissa 182, along which the time in seconds is plotted. Along a first ordinate 183, the rotational speed of the first driving unit 106 is plotted in 1/min, which corresponds to a first measurement curve 186. Along a second ordinate 184, the (electrically provided) torque of the second driving unit 108 is plotted in mN·m, which corresponds to a second measurement curve 187. Along a third ordinate 185, the deflection angle of the second driving unit 108 is plotted in rad, which corresponds to a third measurement curve 188.

The illustration according to FIG. 7 corresponds to the illustration according to FIG. 6 with the difference that according to FIG. 6 the velocity in the negative direction and according to FIG. 7 the velocity in the positive direction is illustrated. Diagram 190 therefore corresponds to diagram 180 with the proviso that measurement curve 186′ corresponds to the measurement curve 186, measurement curve 187′ corresponds to the measurement curve 187 and measurement curve 188′ corresponds to the measurement curve 188.

Now again referring to FIG. 6, during the illustrated analysis, the first driving unit 106 configured as a lower motor moves at a constant velocity, while a spring behavior is simulated by an electric motor with the second driving unit 108 configured as an upper motor. While the lower motor rotates, the bodies 102, 104 adhere to each other. Now the deflection angle at the upper motor increases, see measurement curve 188. The torque at the upper motor increases linearly, see measurement curve 187. From a certain point, the second body 104 detaches from the first body 102, whereby the deflection angle and the torque snap back. Thereafter, the process starts from the beginning.

As can be recognized by means of measurement curve 186, the snapping back at the lower motor causes a certain feedback. This feedback can be suppressed by increasing the moment of inertia at the lower motor.

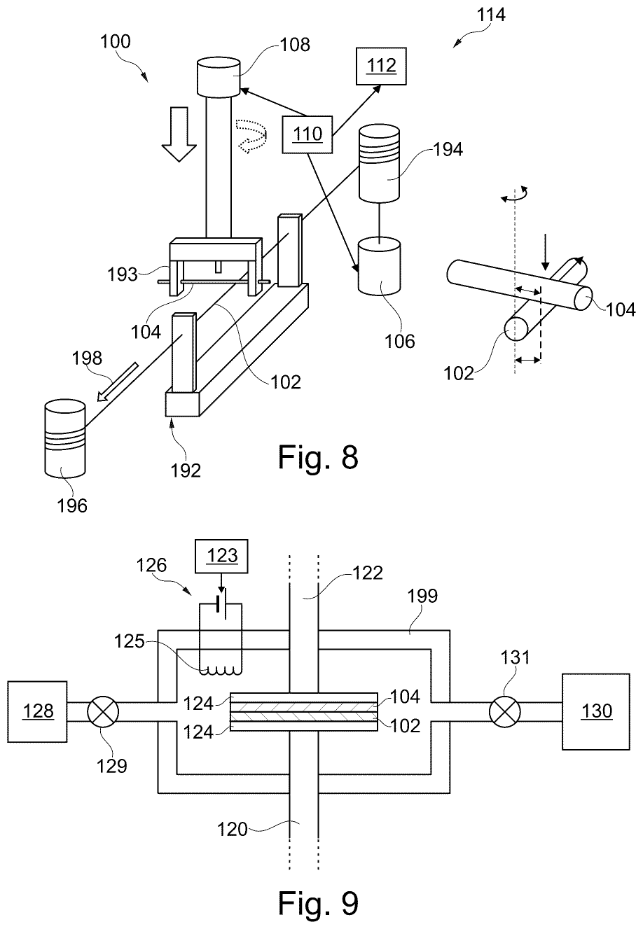

FIG. 8 shows a part of a tribometer 100 for measuring thread-shaped (German: fadenförmig) bodies 102, 104 of a tribo pair according to an exemplary embodiment of the disclosure.

According to FIG. 8, a first thread-shaped body 102 is mounted on a thread holder (German: Fadenhalterung) 192 and can be unwound from a first thread roll 194 and wound onto a second thread roll 196. During operation, a longitudinal movement 198 of the first thread-shaped body 102 occurs. A corresponding driving energy is provided by means of a first driving unit 106. A second thread-shaped body 104 on a thread holder 193 is in frictional contact with the first thread-shaped body 102 and is driven by means of the second driving unit 108. The tribological properties between the bodies 102, 104 can be determined, as described above.

FIG. 9 shows a part of a tribometer 100 according to an exemplary embodiment of the disclosure. According to FIG. 9, the receiving unit 124 together with bodies 102, 104 is accommodated in a conditioning chamber 199.

FIG. 9 first shows that a tempering unit 126 for tempering the tribo pair during the determination of tribological information can be provided. For example, the tempering unit 126 can comprise an electric resistance heater 125, which can be controllable by means of a temperature controller 123.

The tribometer 100 can also comprise a moisture generator 128 for moistening the tribo pair from the bodies 102, 104 during the determination of tribological information. In order to adjust a desired degree of moisture in the interior of the conditioning chamber 199, a moisture control valve 129 can be correspondingly controlled.

Furthermore, the tribometer 100 can comprise a gas environment adjusting unit 130 for adjusting a gas environment in an ambience of the tribo pair from the bodies 102, 104 during the determination of tribological information. In order to adjust a desired gas environment in the interior of the conditioning chamber 199, a gas environment valve 131 can be correspondingly controlled. For example, a noble gas atmosphere can be adjusted in the conditioning chamber 199 in order to avoid an oxidation of the bodies 102, 104.

In addition, it should be noted that “comprising” does not exclude any other elements or steps and “a” or “an” does not exclude a plurality. Furthermore, it should be noted that features or steps which have been described with reference to one of the above exemplary embodiments can also be used in combination with other features or steps of other exemplary embodiments described above. Reference signs in the claims are not to be interpreted as a restriction.

1-28. (canceled)

29. A tribometer for determining tribological information between a tribo pair of a first body and a second body coupled to the first body, wherein the tribometer comprises:
a first driving unit for driving the first body and the second body coupled thereto to perform a deflection;
a second driving unit for applying a force impact to the second body which force impact is acting in the opposite direction to the deflection;
a control unit configured to control the second driving unit such that the force impact on the second body generated by means of the second driving unit is increased with increasing deflection of the first body and the second body generated by means of the first driving unit until the second body detaches from the first body; and
a determination unit for determining the tribological information based on a behavior of the tribo pair during said control.

30. The tribometer according to claim 29,
wherein the first driving unit is configured to rotationally drive the first body and the second body to perform an angular deflection; and
wherein the second driving unit is configured to apply a torque to the second body which torque is acting in the opposite direction to the angular deflection.

31. The tribometer according to claim 29,
wherein the first driving unit is configured to linearly drive the first body and the second body to perform a longitudinal deflection; and
wherein the second driving unit is configured to apply a longitudinal force impact to the second body which longitudinal force impact is acting in the opposite direction to the longitudinal deflection.

32. The tribometer according to claim 29, wherein the control unit is configured to control the first driving unit and the second driving unit in a coordinated manner.

33. The tribometer according to claim 29, wherein the determination unit is configured to determine the tribological information based on a time profile of a deflection of the second body.

34. The tribometer according to claim 29, wherein the control unit is configured to repeat the driving, the applying and the controlling at least once after the detachment.

35. The tribometer according to claim 29, wherein the control unit is configured to control the second driving unit such that the force impact on the second body generated by means of the second driving unit is increased proportionally to the deflection of the first body and the second body generated by means of the first driving unit until the second body detaches from the first body.

36. The tribometer according to claim 29, wherein the control unit is configured to control the second driving unit such that the force impact on the second body generated by means of the second driving unit is increased non-linearly to the deflection of the first body and the second body generated by means of the first driving unit until the second body detaches from the first body.

37. The tribometer according to claim 29, wherein the second driving unit is a measuring motor of a tribometer that can also be operated in a rheometer configuration.

38. The tribometer according to claim 29, comprising at least one of the following features:
comprising a sensor unit for detecting a time profile of a deflection of the second body as a basis for determining the tribological information; and
comprising an acceleration sensor for detecting acceleration information regarding the deflection.

39. The tribometer according to claim 29, comprising at least one of the following features:
wherein the first driving unit is arranged below the tribo pair and the second driving unit is arranged above the tribo pair; and
wherein a first driving axis of the first driving unit is aligned along a second driving axis of the second driving unit.

40. The tribometer according to claim 29, comprising a receiving device for replaceably receiving the tribo pair.

41. The tribometer according to claim 29, wherein the control unit is configured to adjust the force impact generated by means of the second driving unit according to a user specification.

42. The tribometer according to claim 29, comprising at least one of the following features:
wherein the control unit is configured to control the first driving unit at a constant rotational speed;
comprising a tempering unit for tempering the tribo pair during the determination of tribological information;
comprising a moisture generator for moistening the tribo pair during the determination of tribological information; and
comprising a gas environment adjusting unit for adjusting a gas environment in an ambience of the tribo pair during the determination of tribological information.

43. The tribometer according to claim 29, comprising a further determination unit which is configured to determine further information of the tribo pair during the determination of tribological information.

44. The tribometer according to claim 43, wherein the further determination unit is configured to determine information relating to at least one of an acoustic emission, an electrical conductivity, a dielectric property, a spectroscopic property and an optical property of the tribo pair.

45. An arrangement, comprising:
a tribometer according to claim 29; and
the tribo pair composed of the first body coupled to the first driving unit and the second body coupled to the second driving unit.

46. The arrangement according to claim 45, comprising at least one of the following features:
wherein the first body and the second body are directly adjacent to each other; and
comprising an intermediate medium between the first body and the second body.

47. A method for determining tribological information between a tribo pair of a first body and a second body coupled to the first body, wherein the method comprises:
driving the first body and the second body coupled thereto to perform a deflection by means of a first driving unit;
applying a force impact to the second body which force impact is acting in the opposite direction to the deflection by means of a second driving unit;
controlling the second driving unit such that the force impact on the second body generated by means of the second driving unit is increased with increasing deflection of the first body and the second body generated by means of the first driving unit until the second body detaches from the first body; and
determining the tribological information based on a behavior of the tribo pair during said control.

48. The method according to claim 47, wherein the determination of the tribological information comprises characterizing a backlash between the first body and the second body.
